(19) United States
(12) Patent Application Publication
(10) Pub. No.: US 2017/0187809 A1
(43) Pub. Date: Jun. 29, 2017

(54) METHOD AND ELECTRONIC APPARATUS FOR CONTROLLING SMART HOME DEVICE

(71) Applicants: Le Holdings (Beijing) Co., Ltd., Beijing (CN); LE SHI INTERNET INFORMATION TECHNOLOGY CORP. BEIJING, Beijing (CN)

(72) Inventors: Ren Chen, Beijing (CN); Xi Yang, Beijing (CN)

(21) Appl. No.: 15/247,156

(22) Filed: Aug. 25, 2016

Related U.S. Application Data
(63) Continuation of application No. PCT/CN2016/088115, filed on Jul. 1, 2016.

(30) Foreign Application Priority Data
Dec. 23, 2015 (CN) 201510977730.1

(51) Int. Cl. H04L 29/08; H04L 12/28

(52) U.S. Cl. CPC H04L 67/125; H04L 12/2816

(57) ABSTRACT

The present invention discloses a method and an electronic apparatus for controlling smart home device including: acquiring a device controlling message of a conditional smart home device and a device controlling message of a motion smart home device as the control device disposed in advanced satisfies an execution condition; when the control device satisfies the execution condition, executing a control of the conditional smart home device according to the device controlling message of the conditional smart home device; when the control of the conditional smart home device is executed successfully, executing a control of the motion smart home device according to the device controlling message of the motion smart home device. The controlling efficiency for smart home devices is raised in the embodiments of the present application.

### CROSS REFERENCE TO RELATED APPLICATIONS

This application is a continuation of PCT International Application No. PCT/CN2016/088115, filed on Jul. 1, 2016, which is based upon Chinese Patent Application No. 201510977730.1, titled as “METHOD AND DEVICE FOR CONTROLLING SMART HOME DEVICE” and filed on Dec. 23, 2015, the entire contents of which are incorporated herein by reference.

### TECHNICAL FIELD

The application relates to the field of smart home technology, and more particularly to method and electronic apparatus for controlling smart home device.

### BACKGROUND

When the home intelligence develops, more and more smart home devices are produced. A smart home device is one kind of device having a network function and capable of implementing monitoring via a control device. Thereby a user can monitor and control smart home devices via the network to provide various functions including the control of appliance, the control of lighting, the control of curtain and the anti-theft alarm.

In the conventional technology, monitoring for smart home devices is carried out via the applications installed in control devices such as cell phones, PCs, etc. Only one single smart home device could be monitored in each operating. However, in a practical application, for example: after a user arrives home and unlocks the electronic door locker, it is necessary to disable the security monitoring and turn on lighting devices in the house. However, according to the conventional technical solutions, the user has to respectively operate the security monitoring and the lighting devices via the control device, so the operating process is very complicated.

### SUMMARY

The purpose of the application is to provide a method and an electronic apparatus for controlling smart home device configured to solve the technical problems regarding complicated operating of a plurality of related smart devices.

In order to solve the above technical problems, this application discloses a method for controlling smart home devices, and this application is applied to a control device. The method includes:

Acquiring a device controlling message of a conditional smart home device and a device controlling message of a motion smart home device as the control device disposed in advanced satisfies an execution condition;

When the control device satisfies the execution condition, executing a control of the conditional smart home device according to the device controlling message of the conditional smart home device;

When the control of the conditional smart home device is executed successfully, executing a control of the motion smart home device according to the device controlling message of the motion smart home device.

The present application further discloses a non-volatile computer storage medium storing computer-executable instructions, the computer-executable instructions are configured to implement any of methods for controlling smart home devices above in the present application.

This application further discloses an electronic apparatus comprising a processor; and a memory; wherein, the memory stores a program which could be processed by the at least one processor, the instruction is executed by the at least one processor so that the at least one processor is capable of implementing any of methods for controlling smart home devices above in the present application.

Comparing to the prior art, this application can obtain technical effects below:

In the method and electronic apparatus for controlling smart home device in the embodiments of this application, after the control of the conditional home device is executed successfully, the control of the motion smart home device is triggered. Thereby, the control of each single device for monitoring the smart home device in the prior art has been changed, and the linked operation between the conditional smart home device and the motion smart home device is achieved. Therefore, the control efficiency is raised and the time the user spends on controlling the smart home devices one by one is saved so that it is convenient for the user to manage and operate the smart home devices.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for controlling smart home device in one embodiment of the present application;

FIG. 2 is a flow chart of a method for controlling smart home device in another embodiment of the present application;

FIG. 3 is a schematic diagram of a device for controlling smart home device in one embodiment of the present application;

FIG. 4 is a schematic diagram of a device for controlling smart home device in another embodiment of the present application; and

FIG. 5 is a schematic diagram of an electronic apparatus for implementing methods for controlling smart home device in one embodiment of the present application.

### DETAILED DESCRIPTION

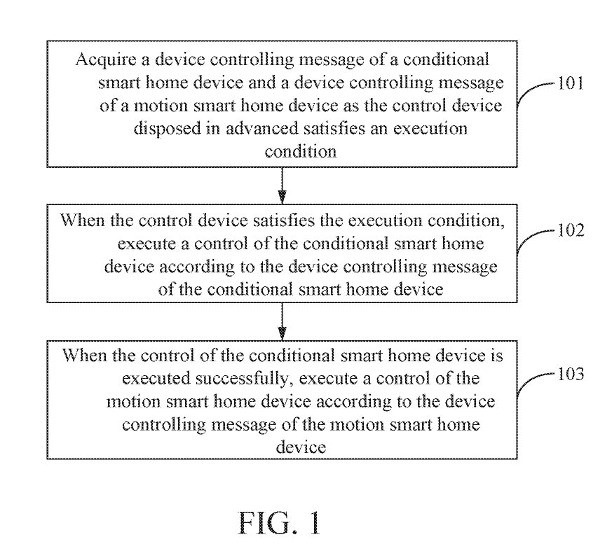

FIG. 1 is a method for controlling smart home device adapted for a server provided in the present application. The server may be a server device configured to provide multi-channel video screen to a broadcasting station. The method includes the following steps S101˜S104.

In order to clarify the purpose, technical solutions, and merits of the present application, the technical solutions in the embodiments of the present application are illustrated clearly and fully with figures of the embodiments of the present application. Obviously, the illustrated embodiments are not all embodiments but part of embodiments of the present application. Based on the embodiments of the present application, other embodiments obtained by persons having ordinary skills in the art without creative efforts provided are within the scope of the present application.

A smart home device is a device having a network function and capable of implementing monitoring via a control device. A user usually monitors and controls smart home devices via the network to carry out various functions including the control of appliance, the control of lighting, the control of curtain and the anti-theft alarm.

After a user arrives home and unlocks the electronic door locker, it is necessary for the user to disable the security monitoring and turn on lighting devices in the house under the conditional operation of unlocking the electronic door locker; or the user turns on TV in a theater mode via a control device. Under the conditional operation of turning on TV in the theater mode, it is necessary to close the curtain and switch the light via the control device. However, the control device has to operate each smart home device independently so that the corresponding function of each smart home device could be implemented. The operating process is more complicated.

Therefore, the inventor provides technical solutions of embodiments of the present application after doing a series of researches so that the efficient controls for smart home devices and the operations for concurrently controlling a plurality of related smart home devices are achieved. When the control device satisfies the execution condition, a control of the conditional smart home device is executed. When the control of the conditional smart home device is executed successfully, a control of the motion smart home device is executed. Thereby, the linked operation between the conditional smart home device and the motion smart home device is achieved. The controlling efficiency and the intelligence are raised and the time for controlling smart home devices one by one is saved so that it is convenient for the user to manage and operate the smart home devices.

The technical solutions of the present application are clearly described below with the figures.

FIG. 1 is a flow chart of a method for controlling smart home device in one embodiment of the present application. The method can include the several steps in following:

101: Acquire a device controlling message of a conditional smart home device and a device controlling message of a motion smart home device as the control device disposed in advanced satisfies an execution condition.

The execution condition satisfied by the control device can include: an executing cycle of each week and a specified time of each single day, for example: the related operations of the control device can be satisfied at 7:30 on Tuesday and Wednesday. The same operation is executed cyclically on Tuesday and Wednesday.

The device controlling message of the conditional smart home device can include the name and the status of the conditional smart home device; the device controlling message of the motion smart home device can include the name and the status of the motion smart home device.

102: When the control device satisfies the execution condition, execute a control of the conditional smart home device according to the device controlling message of the conditional smart home device.

When the control device satisfies the execution condition, first of all, execute a control of the conditional smart home device, for example, the conditional smart home devices including an alarm of a cell phone and lights of a bedroom are automatically turned on when it is 7:30 on Wednesday. Of course, the alarm of the cell phone could be set to ring regularly or ring once. The lights of the bedroom could be set to be in a yellow light mode or a white light mode or a dimmer mode. Thereby the user can implement classified controls for all kinds of smart home devices according to actual demands.

103: When the control of the conditional smart home device is executed successfully, execute a control of the motion smart home device according to the device controlling message of the motion smart home device.

When the control of the conditional smart home device is executed successfully, the execution for a control of the motion smart home device is turned on. The successful execution for the control of the conditional smart home device is the triggering moment of turning on the motion smart home device so that a client implements linked operations for the related devices according to actual demands.

In another embodiment, when there is a plurality of conditional smart home devices, for example: it may be inefficient to wake the user up just using the cell phone alarm in the morning. The user may set both of the cell phone alarm and the bedroom lights as the conditional smart home devices having a wake-up function. After the controls of both the cell phone alarm and the bedroom lights as the conditional smart home devices are executed to wake the user up, it is normal that the user need to wash the face and rinse the mouth with hot water and have breakfast. Thus, the user needs to turn on the microwave and the water heater as the motion smart home devices. In other words, the execution for the motion smart home device such as microwave, the water heater has to be turned on after the execution for the conditional smart home device such as cell phone alarm or bedroom lights is successful. If the execution for the motion smart home device is turned on after the execution for the conditional smart home device is successful, it likely causes the disorder of the execution of another conditional smart home device and the execution of the motion smart home device. It will not meet user demands and likely cause resource wastes. Thus, in the step 103, when the control of the conditional smart home device is executed successfully, execute a control of the motion smart home device according to the device controlling message of the motion smart home device could be:

When the controls of the plurality of conditional smart home devices are executed successfully, the controls of the motion smart home devices are executed according to the device controlling messages of the motion smart home devices.

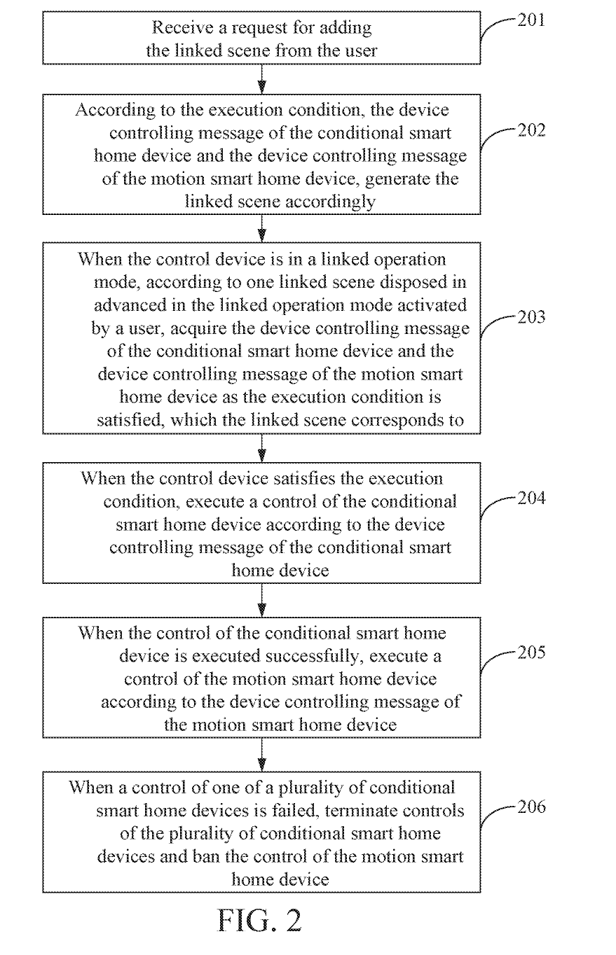

In the embodiments of the present application, in the process of monitoring the smart home devices, when the control device satisfies the execution condition, execute the control of the conditional smart home device. When the control of the conditional smart home device is executed successfully, execute the control of the motion smart home device. Thereby, when the user would like to control a plurality of related smart home device concurrently in the current environment, the user could trigger the conditional smart home device and concurrently execute the control of the motion smart home device by setting execution conditions. There is no need to control the smart home devices one by one via the control device so that the controlling efficiency is raised and the time the user spends on controlling the smart home devices one by one is saved.

Wherein, when the executing condition is satisfied, the device controlling message could be a factory setting, for example: the device controlling message could be set in the client software. The device controlling message is a conventional device controlling message set up by client software developers after considering demands of most people. Of course, the device controlling message could be set up by the user. In another embodiment, a flow chart of a method for controlling smart home device in the present application is shown in FIG. 2, and the method could include several steps below:

201: Receive a request for adding the linked scene from the user.

Wherein, the request for adding the linked scene can include the execution condition, the device controlling message of the conditional smart home device and the device controlling message of the motion smart home device.

After receiving the icon or button for triggering to add the linked scene from the user, a setup interface is popped out so that in the setup interface, the user could set the name, the execution condition, the device controlling message of the conditional smart home device and the device controlling message of the motion smart home device regarding the linked scene. The execution condition could include an executing cycle of each week and a specified time of each single day. The device controlling message of the conditional smart home device can include the name and the corresponding operation status of various conditional smart home devices. The device controlling message of the motion smart home device can include the name and the corresponding operation status of various motion smart home devices. Therefore, a client could set up more specific time and smart home devices which he wants to control according to the actual demands.

In another embodiment, when the user is adding the linked scene, if the user can only add several kinds of inherent executing conditions, several kinds of inherent controls of the conditional smart home devices and the motion smart home devices, for example: according to the inherent conditions, the setting that mostly meets a user's demands is that the air condition is turned on and adjusted to be 25 degree before the user arrives home from work at night. It is not allowed to for the user to set a more practical linked scene according to the weather or off-duty schedule. Therefore, in the step 201, the receiving the request for adding the linked scene from the user can include:

Output a reminding message of setting the execution condition, a reminding message of device control of the conditional smart home device and a reminding message of device control of the motion smart home device;

Receive the request for adding the linked scene triggered by the user according to the reminding message of setting the execution condition, the reminding message of device control of the conditional smart home device and the reminding message of device control of the motion smart home device.

202: According to the execution condition, the device controlling message of the conditional smart home device and the device controlling message of the motion smart home device, generate the linked scene accordingly.

According to the execution condition, the device controlling message of the conditional smart home device and the device controlling message of the motion smart home device, generate the linked scene set with names. The linked scene may be displayed in form of a name and an icon for the user to select a proper linked scene. After the linked scene is selected by the user, the control of the conditional smart home device is executed as the execution condition is satisfied. When the control of the conditional smart home device is executed successfully, the motion smart home device is controlled concurrently so that the client directly realizes the specific setting contents of the scene through the linked scene.

203: When the control device is in a linked operation mode, according to one linked scene disposed in advanced in the linked operation mode activated by a user, acquire the device controlling message of the conditional smart home device and the device controlling message of the motion smart home device as the execution condition is satisfied, which the linked scene corresponds to.

When the control device is in a linked operation mode, the linked scene disposed in advanced can be displayed in the displaying interface for users to select. Moreover, after triggering one linked scene, acquire the device controlling message of the conditional smart home device and the device controlling message of the motion smart home device as the execution condition is satisfied in the linked scene so that the client more conveniently selects the smart home device to be controlled by selecting the linked scene.

204: When the control device satisfies the execution condition, execute a control of the conditional smart home device according to the device controlling message of the conditional smart home device.

205: When the control of the conditional smart home device is executed successfully, execute a control of the motion smart home device according to the device controlling message of the motion smart home device.

206: When a control of one of a plurality of conditional smart home devices is failed, terminate controls of the plurality of conditional smart home devices and ban the control of the motion smart home device.

When there is a plurality of conditional smart home devices, for example: if the control of one of the cell phone alarm and the lights of the bedroom is failed, it is possible that the conditional smart home device controlled successfully execute an error operation, or the conditional smart home device controlled successfully malfunctions. The user has to check the setting message in the control device or the malfunction of operation in the scene. Therefore, terminating controls of the plurality of conditional smart home devices and banning the control of the motion smart home device could prevent resource waste caused by keeping the operation on the one hand, and increase the safety performance as the malfunction is being checked on the other hand.

The steps 203˜205 shown in FIG. 2 are similar to the steps 101˜103 shown in FIG. 1 and not repeated here.

In the embodiment, in the step of receiving a request for adding the linked scene from the user, the user defines the linked scene and the execution condition, the name, the number and the operating status of the device in the linked scene. When the user triggers to select the linked scene, the specific controls of smart home devices in the linked scene would be respectively executed as the execution condition is satisfied. Thereby, when the user would like to control a plurality of related smart home device concurrently in the current environment, the user could trigger the conditional smart home device and concurrently execute the control of the motion smart home device by setting execution conditions. There is no need to control the smart home devices one by one via the control device so that the controlling efficiency is raised and the time the user spends on controlling the smart home devices one by one is saved.

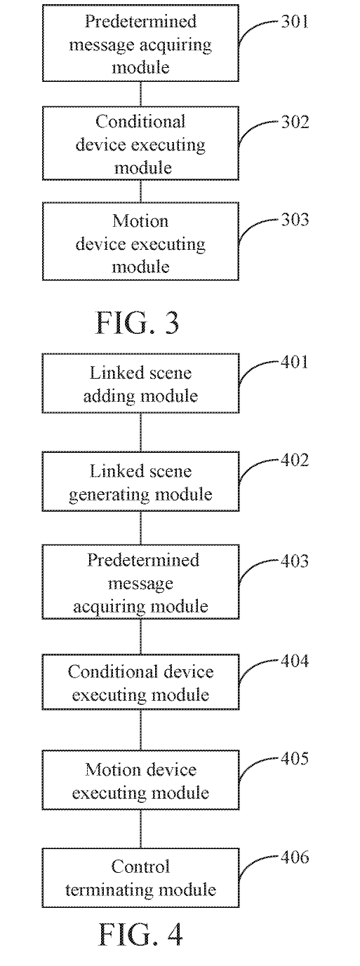

FIG. 3 is a schematic diagram of a device for controlling smart home device in one embodiment of the present application. The device can include:

A predetermined message acquiring module 301 configured to acquire a device controlling message of a conditional smart home device and a device controlling message of a motion smart home device as the control device disposed in advanced satisfies an execution condition.

The execution condition satisfied by the control device can include: an executing cycle of each week and a specified time of each single day, for example: the related operations of the control device can be satisfied at 7:30 on Tuesday and Wednesday. The same operation is executed cyclically on Tuesday and Wednesday.

The device controlling message of the conditional smart home device can include the name and the status of the conditional smart home device; the device controlling message of the motion smart home device can include the name and the status of the motion smart home device.

A conditional device executing module 302 configured to execute a control of the conditional smart home device according to the device controlling message of the conditional smart home device when the control device satisfies the execution condition.

When the control device satisfies the execution condition, first of all, execute a control of the conditional smart home device, for example, the conditional smart home devices including an alarm of a cell phone and lights of a bedroom are automatically turned on when it is 7:30 on Wednesday. Of course, the alarm of the cell phone could be set to ring regularly or ring once. The lights of the bedroom could be set to be in a yellow light mode or a white light mode or a dimmer mode. Thereby the user can implement classified controls for all kinds of smart home devices according to actual demands.

A motion device executing module 303 configured to execute a control of the motion smart home device according to the device controlling message of the motion smart home device when the control of the conditional smart home device is executed successfully.

When the control of the conditional smart home device is executed successfully, the execution for a control of the motion smart home device is turned on. The success of the control of the conditional smart home device is the moment of triggering the motion smart home device so that a client implements linked operations for the related devices according to actual demands.

In another embodiment, when there is a plurality of conditional smart home devices, for example: it may be inefficient to wake the user up just using the cell phone alarm in the morning. The user may set both of the cell phone alarm and the bedroom lights as the conditional smart home devices having a wake-up function. After the controls of both the cell phone alarm and the bedroom lights as the conditional smart home devices are executed to wake the user up, it is normal that the user need to wash the face and rinse the mouth with hot water and have breakfast. Thus, the user needs to turn on the microwave and the water heater as the motion smart home devices. In other words, the execution for the motion smart home device (microwave and the water heater) has to be turned on after the execution for the conditional smart home device (cell phone alarm or bedroom lights) is successful. If the execution for the motion smart home device is turned on after the execution for the conditional smart home device is successful, it likely causes the disorder of the execution of another conditional smart home device and the execution of the motion smart home device. It will not meet user demands and likely cause resource wastes. Thus, the motion device executing module 303 is further configured to:

When the controls of a plurality of conditional smart home devices are executed successfully, the controls of the motion smart home devices are executed according to the device controlling messages of the motion smart home devices.

In the embodiments of the present application, in the process of monitoring the smart home devices, when the control device satisfies the execution condition, execute the control of the conditional smart home device. When the control of the conditional smart home device is executed successfully, execute the control of the motion smart home device. Thereby, when the user would like to control a plurality of related smart home device concurrently in the current environment, the user could trigger the conditional smart home device and concurrently execute the control of the motion smart home device by setting execution conditions. There is no need to control the smart home devices one by one via the control device so that the controlling efficiency is raised and the time the user spends on controlling the smart home devices one by one is saved.

Wherein, when the executing condition is satisfied, the device controlling message could be a factory setting, for example: the device controlling message could be set in the client software. The device controlling message is a conventional device controlling message set up by client software developers after considering demands of most people. Of course, the device controlling message could be set up by the user. In another embodiment, a flow chart of a device for controlling smart home device in another embodiment of the present application is shown in FIG. 4, and the device could include:

A linked scene adding module 401 configured to receive a request for adding the linked scene from the user.

Wherein the request for adding the linked scene includes the execution condition, the device controlling message of the conditional smart home device and the device controlling message of the motion smart home device;

After receiving the icon or button for triggering to add the linked scene from the user, a setup interface is popped out so that in the setup interface, the user could set the name, the execution condition, the device controlling message of the conditional smart home device and the device controlling message of the motion smart home device regarding the linked scene. The execution condition could include an executing cycle of each week and a specified time of each single day. The device controlling message of the conditional smart home device can include the name and the corresponding operation status of various conditional smart home devices. The device controlling message of the motion smart home device can include the name and the corresponding operation status of various motion smart home devices. Therefore, a client could set up more specific time and smart home devices which he wants to control according to the actual demands.

In another embodiment, when the user is adding the linked scene, if the user can only add several kinds of inherent executing conditions, several kinds of inherent controls of the conditional smart home devices and the motion smart home devices, for example: according to the inherent conditions, the setting that mostly meets a user's demands is that the air condition is turned on and adjusted to be 25 degree before the user arrives home from work at night. It is not allowed to for the user to set a more practical linked scene according to the weather or off-duty schedule. Thus, the linked scene adding module 401 could include:

A reminding message outputting module configured to output a reminding message of setting the execution condition, a reminding message of device control of the conditional smart home device and a reminding message of device control of the motion smart home device;

An adding request receiving module configured to receive the request for adding the linked scene triggered by the user according to the reminding message of setting the execution condition, the reminding message of device control of the conditional smart home device and the reminding message of device control of the motion smart home device.

A linked scene generating module 402 is configured to generate the linked scene accordingly according to the execution condition, the device controlling message of the conditional smart home device and the device controlling message of the motion smart home device.

According to the execution condition, the device controlling message of the conditional smart home device and the device controlling message of the motion smart home device, generate the linked scene set with names. The linked scene may be displayed in form of a name and an icon for the user to select a proper linked scene. After the linked scene is selected by the user, the control of the conditional smart home device is executed as the executing condition meets the requirements. When the control of the conditional smart home device is executed successfully, the motion smart home device is controlled concurrently so that the client directly realizes the specific setting contents of the scene through the linked scene.

The predetermined message acquiring module 403 is further configured to acquire the device controlling message of the conditional smart home device and the device controlling message of the motion smart home device as the execution condition is satisfied, which the linked scene corresponds to, when the control device is in a linked operation mode, according to one linked scene disposed in advanced in the linked operation mode activated by a user.

When the control device is in a linked operation mode, the linked scene disposed in advanced can be displayed in the displaying interface for users to select. Moreover, after triggered one linked scene, acquire the device controlling message of the conditional smart home device and the device controlling message of the motion smart home device as the execution condition is satisfied in the linked scene so that the client more conveniently selects the smart home device to be controlled by selecting the linked scene.

A conditional device executing module 404 is configured to execute a control of the conditional smart home device according to the device controlling message of the conditional smart home device when the control device satisfies the execution condition.

A motion device executing module 405 is configured to execute a control of the motion smart home device according to the device controlling message of the motion smart home device when the control of the conditional smart home device is executed successfully.

A control terminating module 406 is configured to terminate controls of a plurality of conditional smart home devices and ban the control of the motion smart home device when a control of one of the plurality of conditional smart home devices is failed.

When there is a plurality of conditional smart home device, for example: if the control of one of the cell phone alarm and the lights of the bedroom is failed, the conditional smart home device controlled successfully may execute an error operation, or the conditional smart home device controlled successfully may malfunction. The user has to check the setting message in the control device or the malfunction of operation in the scene. Therefore, terminating controls of the plurality of conditional smart home devices and banning the control of the motion smart home device could prevent resource waste caused by keeping the operation on the one hand, and increase the safety performance as processing the malfunction on the other hand.

The functions of the modules 403˜405 shown in FIG. 4 are similar to the functions of the modules 201˜203 shown in FIG. 3, and not repeated here.

In the embodiment, in the step of receiving a request for adding the linked scene from the user, the user defines the linked scene and the execution condition, the name, the number and the operating status of the device in the linked scene. When the user triggers to select the linked scene, the specific controls of smart home devices in the linked scene would be respectively executed as the execution condition is satisfied. Thereby, when the user would like to control a plurality of related smart home device concurrently in the current environment, the user could trigger the conditional smart home device and concurrently execute the control of the motion smart home device by setting execution conditions. There is no need to control the smart home devices one by one via the control device so that the controlling efficiency is raised and the time the user spends on controlling the smart home devices one by one is saved.

Through the technical solutions in the embodiments of the present application, in the embodiments of the present application, when the user would like to control a plurality of related smart home devices, the user could achieve the linked operation between the conditional smart home device and the motion smart home device by triggering one of a plurality of linked scenes. Thereby the control efficiency and intelligence are raised and the time the user spends on controlling the smart home devices one by one is saved. It is convenient for the user to manage and operate the smart home devices.

This present application further provides a non-volatile computer storage medium storing computer-executable instructions, and the computer-executable instructions are capable of implementing methods for controlling smart home device in any of above embodiments

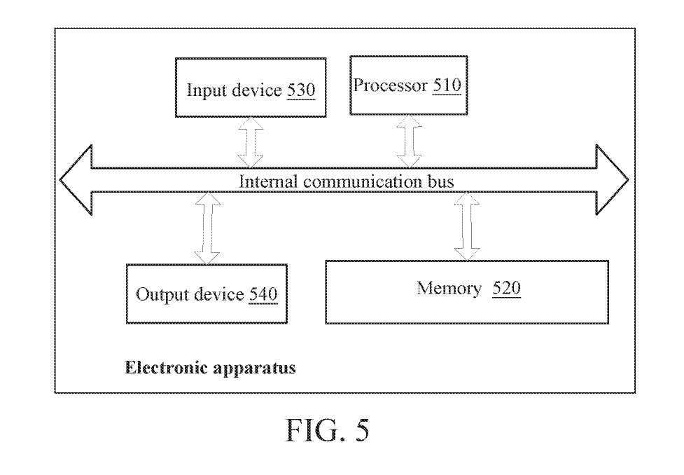

The present application further provides an electronic apparatus for controlling smart home device. The schematic diagram is shown in FIG. 5. The apparatus includes:

One or more processors 510 and a memory 520. The processor 510 is used as an example in FIG. 5.

The apparatus for implementing methods for controlling smart home device further includes: an input device 530 and an output device 540.

The processor 510, the memory 520, the input device 530 and the output device 540 could be connected to each other via a bus or other members for connection. In FIG. 5, they are connected via the bus in the embodiment.

The memory 520 is one kind of non-volatile computer-readable storage mediums applicable to store non-volatile software programs, non-volatile computer-executable programs and modules; for example, the program instructions and the function modules (the predetermined message acquiring module 301, the conditional device executing module 302 and the motion device executing module 303 in FIG. 3) corresponding to the method for controlling smart home device in the embodiments are respectively a computer-executable program and a computer-executable module. The processor 510 executes function applications and data processing of the server by running the non-volatile software programs, non-volatile computer-executable programs and modules stored in the memory 520, and thereby the methods for controlling smart home device in the aforementioned embodiments are achievable.

The memory 520 can include a program storage area and a data storage area, wherein the program storage area can store an operating system and at least one application program required for a function; the data storage area can store data created according to the usage of a processing apparatus operated in list items. Furthermore, the memory 520 can include a high speed random-access memory, and further include a non-volatile memory such as at least one disk storage member, at least one flash memory member, and other non-volatile solid-state memory member. In some embodiments, the memory 520 can have a remote connection with the processor 510, and such memory can be connected to the device for controlling smart home device by a network. The aforementioned network includes, but not limited to, internet, intranet, local area network, mobile communication network and combination thereof.

The input device 530 can receive digital or character information, and generate a key signal input regarding a user setup of the device for controlling smart home device and a function control. The output device 540 can include a displaying unit such as screen.

The one or more modules are stored in the memory 520. When the one or more modules are executed by one or more processor 510, the method for controlling smart home device is performed.

The aforementioned product can execute the method provided by the embodiments of the present application and have a block module and benefits corresponding to the executing method. Technical details not described clearly in the embodiment can be found in the method provided by the embodiments of the present application.

The electronic apparatus in the embodiments of the present application may be presence in many forms including, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The embodiments of the device described above are just exemplary, wherein the units described as separate components could be or could not be physically separated from each other. The components used as units could be or could not be physical units. The components could be located in one place or could be spread over multiple network elements. According to the actual demand, part of modules or all modules can be selected to achieve the purpose of the embodiments of the present invention. Persons having ordinary skills in the art could realize and implement the embodiments of the present invention without providing creative efforts.

Through the above descriptions of embodiments, those skilled in the art can clearly realize each embodiment can be implemented using software plus essential common hardware platforms. Certainly each embodiment can be implemented using hardware. Based on the understanding, the above technical solutions or part of the technical solutions contributing to the prior art could be embodied in form of software products. The computing software products can be stored in a computer-readable storage medium such as ROM/RAM, disk, compact disc, etc. The computing software products include several instructions configured to make a computing device (a personal computer, a server, or internet device, etc) carry out the methods in each embodiments or part of methods in the embodiments.

Finally, it should be noted that: the above embodiments are just used for illustrating the technical solutions of the present application and not for limiting the present application. Even though the present application is illustrated clearly referring to the previous embodiments, persons having ordinary skills in the art should realize the technical solutions described in the aforementioned embodiments can be modified or part of technical features can be displaced equivalently. The modification or the displacement would not make corresponding essentials of the technical solutions out of spirit and scope of the technical solution of each embodiment of the present application.

What is claimed is:

1. A method for controlling smart home device, adapted for a control device, the method comprising:
acquiring a device controlling message of a conditional smart home device and a device controlling message of a motion smart home device as the control device disposed in advanced satisfies an execution condition;
when the control device satisfies the execution condition, executing a control of the conditional smart home device according to the device controlling message of the conditional smart home device; and
when the control of the conditional smart home device is executed successfully, executing a control of the motion smart home device according to the device controlling message of the motion smart home device.

2. The method according to claim 1, wherein the acquiring the device controlling message of the conditional smart home device and the device controlling message of the motion smart home device as the control device disposed in advanced satisfies the execution condition comprises:
when the control device is in a linked operation mode, according to one linked scene disposed in advanced in the linked operation mode activated by a user, acquiring the device controlling message of the conditional smart home device and the device controlling message of the motion smart home device as the execution condition is satisfied, which the linked scene corresponds to.

3. The method according to claim 2, wherein one linked scene in the linked operation mode is generated in advanced by a method comprising:
receiving a request for adding the linked scene from the user, wherein the request for adding the linked scene comprises the execution condition, the device controlling message of the conditional smart home device and the device controlling message of the motion smart home device; and
according to the execution condition, the device controlling message of the conditional smart home device and the device controlling message of the motion smart home device, generating the linked scene accordingly.

4. The method according to claim 3, wherein the receiving the request for adding the linked scene from the user comprises:
outputting a reminding message of setting the execution condition, a reminding message of device control of the conditional smart home device and a reminding message of device control of the motion smart home device;
receiving the request for adding the linked scene triggered by the user according to the reminding message of setting the execution condition, the reminding message of device control of the conditional smart home device and the reminding message of device control of the motion smart home device.

5. The method according to claim 1, wherein the method further comprising:
when a control of one of a plurality of conditional smart home devices is failed, terminating controls of the plurality of conditional smart home devices and banning the control of the motion smart home device.

6. A non-volatile computer storage medium storing computer-executable instructions, the computer-executable instructions set as:
acquiring a device controlling message of a conditional smart home device and a device controlling message of a motion smart home device as the control device disposed in advanced satisfies an execution condition;
executing a control of the conditional smart home device according to the device controlling message of the conditional smart home device when the control device satisfies the execution condition; and
executing a control of the motion smart home device according to the device controlling message of the motion smart home device when the control of the conditional smart home device is executed successfully.

7. A electronic apparatus, comprising;
at least one processor; and
a memory communicatively connected to the at least one processor; wherein,
the memory stores a program which could be processed by the at least one processor, the instruction is executed by the at least one processor so that the at least one processor is capable of:
acquiring a device controlling message of a conditional smart home device and a device controlling message of a motion smart home device as the control device disposed in advanced satisfies an execution condition;
executing a control of the conditional smart home device according to the device controlling message of the conditional smart home device when the control device satisfies the execution condition; and
executing a control of the motion smart home device according to the device controlling message of the motion smart home device when the control of the conditional smart home device is executed successfully.

8. The non-volatile computer storage medium according to claim 6, wherein the acquiring a device controlling message of a conditional smart home device and a device controlling message of a motion smart home device as the control device disposed in advanced satisfies an execution condition comprising: acquiring the device controlling message of the conditional smart home device and the device controlling message of the motion smart home device as the execution condition is satisfied, which the linked scene corresponds to, when the control device is in a linked operation mode, according to one linked scene disposed in advanced in the linked operation mode activated by a user.

9. The non-volatile computer storage medium according to claim 8, wherein the computer-executable instructions are further configured to:
receiving a request for adding the linked scene from the user, wherein the request for adding the linked scene comprises the execution condition, the device controlling message of the conditional smart home device and the device controlling message of the motion smart home device; and
generating the linked scene accordingly according to the execution condition, the device controlling message of the conditional smart home device and the device controlling message of the motion smart home device.

10. The device according to claim 9, wherein receiving a request for adding the linked scene from the user comprises:
outputting a reminding message of setting the execution condition, a reminding message of device control of the conditional smart home device and a reminding message of device control of the motion smart home device; and
receiving the request for adding the linked scene triggered by the user according to the reminding message of setting the execution condition, the reminding message of device control of the conditional smart home device and the reminding message of device control of the motion smart home device.

11. The non-volatile computer storage medium according to claim 6, wherein the computer-executable instructions are further configured to:
terminating controls of a plurality of conditional smart home devices and ban the control of the motion smart home device when a control of one of the plurality of conditional smart home devices is failed.

12. The electronic apparatus according to claim 7, wherein, the acquiring a device controlling message of a conditional smart home device and a device controlling message of a motion smart home device as the control device disposed in advanced satisfies an execution condition comprises: acquiring the device controlling message of the conditional smart home device and the device controlling message of the motion smart home device as the execution condition is satisfied, which the linked scene corresponds to, when the control device is in a linked operation mode, according to one linked scene disposed in advanced in the linked operation mode activated by a user.

13. The electronic apparatus according to claim 12, wherein, the procedure is further set for implementing:
receiving a request for adding the linked scene from the user; the request for adding the linked scene comprises the execution condition, the device controlling message of the conditional smart home device and the device controlling message of the motion smart home device; and
generating the linked scene accordingly according to the execution condition, the device controlling message of the conditional smart home device and the device controlling message of the motion smart home device.

14. The electronic apparatus according to claim 13, wherein, the receiving the request for adding the linked scene from the user comprises:
outputting a reminding message of setting the execution condition, a reminding message of device control of the conditional smart home device and a reminding message of device control of the motion smart home device; and
receiving the request for adding the linked scene triggered by the user according to the reminding message of setting the execution condition, the reminding message of device control of the conditional smart home device and the reminding message of device control of the motion smart home device.

15. The electronic apparatus according to claim 7, wherein, the procedure is further set for implementing:
terminating controls of a plurality of conditional smart home devices and ban the control of the motion smart home device when a control of one of the plurality of conditional smart home devices is failed.
